(19) United States
(12) Patent Application Publication
(10) Pub. No.: US 2023/0092103 A1
(43) Pub. Date: Mar. 23, 2023

(54) CONTENT LINKING FOR ARTIFICIAL REALITY ENVIRONMENTS

(71) Applicant: Meta Platforms Technologies, LLC, Menlo Park, CA (US)

(72) Inventors: Ana Garcia Puyol, Mountain View, CA (US); Michelle Pujals, Los Gatos, CA (US); John Nicholas Jitkoff, Seattle, WA (US); Amir Mesguich Havilio, San Francisco, CA (US); Jesse John Mullen, Hayward, CA (US); Cristobal Alvaro Castilla Lacomba, Seattle, WA (US)

(21) Appl. No.: 17/481,200

(22) Filed: Sep. 21, 2021

(51) Int. Cl. G06F 16/955; H04L 29/06; G06F 3/0481; G06T 19/00

(52) U.S. Cl. CPC G06F 16/9558; H04L 67/38; G06F 3/04815; G06T 19/006

(57) ABSTRACT

Various aspects of the subject technology relate to systems, methods, and machine-readable media for linking artificial reality content to a shared artificial reality environment. Various aspects may include receiving a selection of a user representation and a virtual area, such as from a user device. Aspects may include providing the user representation for display in the virtual area. Aspects may also include determining a selected artificial reality application from a plurality of artificial reality applications for use by the user representation in the virtual area. Aspects may also include embedding visual content from the selected artificial reality application into the virtual area, which may be associated with a deep link to the selected artificial reality application. Aspects may include transitioning the user representation between virtual areas while providing an audio element to the user device indicative of other user devices associated with another virtual area.

### TECHNICAL FIELD

The present disclosure generally relates to linking artificial reality content for computer generated shared artificial reality environments.

### BACKGROUND

Interaction between various people over a computer generated shared artificial reality environment involves different types of interaction such as sharing individual experiences in the shared artificial reality environment. When multiple people (e.g., users) are engaged in the shared artificial reality environment, various users may desire to share content such as artificial reality content, artificial reality areas, and/or artificial reality applications with other users. Artificial reality elements that provide users with more options for controlling how to share content may enhance the user experience with respect to interaction in the shared artificial reality environment.

### BRIEF SUMMARY

The subject disclosure provides for systems and methods for linking content in an artificial reality environment such as a shared virtual reality environment. In an aspect, artificial reality elements such as embedded content, indicator elements, and/or deep links are provided to improve connectivity between portions of the artificial reality environment. For example, the elements may facilitate and/or more directly implement travel between different virtual areas (e.g., spaces) of the artificial reality environment. The elements may also improve the ease of sharing and/or loading content between one or more of: different user representations, artificial reality/virtual reality compatible devices, artificial reality/virtual reality applications or areas, and/or the like. The artificial elements of the subject disclosure may advantageously improve connectivity and/or continuity to other users/user representations as a user/user representation travels throughout the artificial reality environment and shares content with other users or devices.

According to one embodiment of the present disclosure, a computer-implemented method for linking artificial reality content to a shared artificial reality environment is provided. The method includes receiving a selection of a user representation and a virtual area. Receiving the request may occur via a user device. The method also includes providing the user representation for display in the virtual area. The method also includes determining, from a plurality of artificial reality applications, a selected artificial reality application for use by the user representation in the virtual area. The method also includes embedding visual content from the selected artificial reality application into the virtual area. The visual content may be associated with a deep link to the selected artificial reality application. The method also includes activating, via the user representation, the deep link between the user device and another virtual area of the selected artificial reality application. The method also includes transitioning the user representation between the virtual area and the another virtual area while providing an audio element to the user device indicative of other user devices associated with the another virtual area.

According to one embodiment of the present disclosure, a system is provided including a processor and a memory comprising instructions stored thereon, which when executed by the processor, causes the processor to perform a method for linking artificial reality content to a shared artificial reality environment. The method includes receiving a selection of a user representation and a virtual area. Receiving the request may occur via a user device. The method also includes providing the user representation for display in the virtual area. The method also includes determining, from a plurality of artificial reality applications, a selected artificial reality application for use by the user representation in the virtual area. The method also includes embedding visual content from the selected artificial reality application into a display of a first user device. The visual content may be associated with a deep link to the selected artificial reality application. The method also includes generating the deep link to the selected artificial reality application for a second user device based on the visual content. The method also includes activating the deep link between the second user device and another virtual area of the selected artificial reality application. The method also includes transitioning the user representation between the virtual area and the another virtual area while providing an audio element to the second user device indicative of other user representations associated with the another virtual area.

According to one embodiment of the present disclosure, a non-transitory computer-readable storage medium is provided including instructions (e.g., stored sequences of instructions) that, when executed by a processor, cause the processor to perform a method for providing a link to artificial reality content in a shared artificial reality environment. The method includes receiving a selection of a user representation and a virtual area. Receiving the request may occur via a user device. The method also includes providing the user representation for display in the virtual area. The method also includes determining, from a plurality of artificial reality applications, a selected artificial reality application for use by the user representation in the virtual area. The method also includes embedding visual content from the selected artificial reality application into the virtual area. The visual content may be associated with a deep link to the selected artificial reality application. The method also includes activating, via the user representation, the deep link between the user device and another virtual area of the selected artificial reality application. The method also includes transitioning the user representation between the virtual area and the another virtual area while providing an audio element to the user device indicative of other user devices associated with the another virtual area.

According to one embodiment of the present disclosure, a system is provided that includes means for storing instructions, and means for executing the stored instructions that, when executed by the means, cause the means to perform a method for linking artificial reality content to a shared artificial reality environment. The method includes receiving a selection of a user representation and a virtual area. Receiving the request may occur via a user device. The method also includes providing the user representation for display in the virtual area. The method also includes determining, from a plurality of artificial reality applications, a selected artificial reality application for use by the user representation in the virtual area. The method also includes embedding visual content from the selected artificial reality application into the virtual area. The visual content may be associated with a deep link to the selected artificial reality application. The method also includes activating, via the user representation, the deep link between the user device and another virtual area of the selected artificial reality application. The method also includes transitioning the user representation between the virtual area and the another virtual area while providing an audio element to the user device indicative of other user devices associated with the another virtual area.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of a device operating environment with which aspects of the subject technology can be implemented.

FIGS. 2A-2B are diagrams illustrating virtual reality headsets, according to certain aspects of the present disclosure.

FIG. 2C illustrates controllers for interaction with an artificial reality environment.

FIG. 3 is a block diagram illustrating an overview of an environment in which some implementations of the present technology can operate.

FIGS. 4A-4B illustrate example views of a user interface in an artificial reality environment, according to certain aspects of the present disclosure.

FIGS. 5A-5B illustrate example views of embedding content in an artificial reality environment, according to certain aspects of the present disclosure.

FIGS. 6A-6B illustrate example views of selecting a destination area of an artificial reality environment, according to certain aspects of the present disclosure.

FIGS. 7A-7B illustrate example views of selecting another destination area of an artificial reality environment, according to certain aspects of the present disclosure.

FIG. 8 illustrates interaction with an artificial reality application according to certain aspects of the present disclosure.

FIGS. 9A-9B illustrate example views of applying audio elements in areas of an artificial reality environment, according to certain aspects of the present disclosure.

FIG. 10 illustrates an example view of an artificial reality collaborative working environment, according to certain aspects of the present disclosure.

FIG. 11 illustrates example views of casting content from a first source to a second source in an artificial reality environment, according to certain aspects of the present disclosure.

FIGS. 12A-12C illustrate example views of embedding visual content from an artificial reality application into a virtual area of an artificial reality environment, according to certain aspects of the present disclosure.

FIG. 13A-13B illustrate sharing content via a user representation in a shared artificial reality environment, according to certain aspects of the present disclosure.

FIG. 14 is an example flow diagram for linking artificial reality content to a shared artificial reality environment, according to certain aspects of the present disclosure.

FIG. 15 is a block diagram illustrating an example computer system which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The disclosed system addresses a problem in virtual or artificial reality tied to computer technology, namely, the technical problem of communication and interaction between artificial reality user representations within a computer generated shared artificial reality environment. The disclosed system solves this technical problem by providing a solution also rooted in computer technology, namely, by linking artificial reality content to the shared artificial reality environment. The disclosed system also improves the functioning of the computer itself because it enables the computer to improve intra computer communications for the practical application of a system of computers generating and hosting the shared artificial reality environment. In particular, the disclosed system provides improved artificial reality elements that improve communication between user representations within the computer generated shared artificial reality environment.

Aspects of the present disclosure are directed to creating and administering artificial reality environments. For example, an artificial reality environment may be a shared artificial reality (AR) environment, a virtual reality (VR), an extra reality (XR) environment, an augmented reality environment, a mixed reality environment, a hybrid reality environment, a non immersive environment, a semi immersive environment, a fully immersive environment, and/or the like. The XR environments may also include AR collaborative working environments which include modes for interaction between various people or users in the XR environments. The XR environments of the present disclosure may provide elements that enable users to feel connected with other users. For example, audio and visual elements may be provided that maintain connections between various users that are engaged in the XR environments. As used herein, “real-world” objects are non-computer generated and AR or VR objects are computer generated. For example, a real-world space is a physical space occupying a location outside a computer and a real-world object is a physical object having physical properties outside a computer. For example, an AR or VR object may be rendered and part of a computer generated XR environment.

Embodiments of the disclosed technology may include or be implemented in conjunction with an artificial reality system. Artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some implementations, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they passthrough the system, such as by adding virtual objects. “Mixed reality” or “MR” refers to systems where light entering a user's eye is partially generated by a computing system and partially composes light reflected off objects in the real-world. For example, a MR headset could be shaped as a pair of glasses with a pass-through display, which allows light from the real-world to passthrough a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

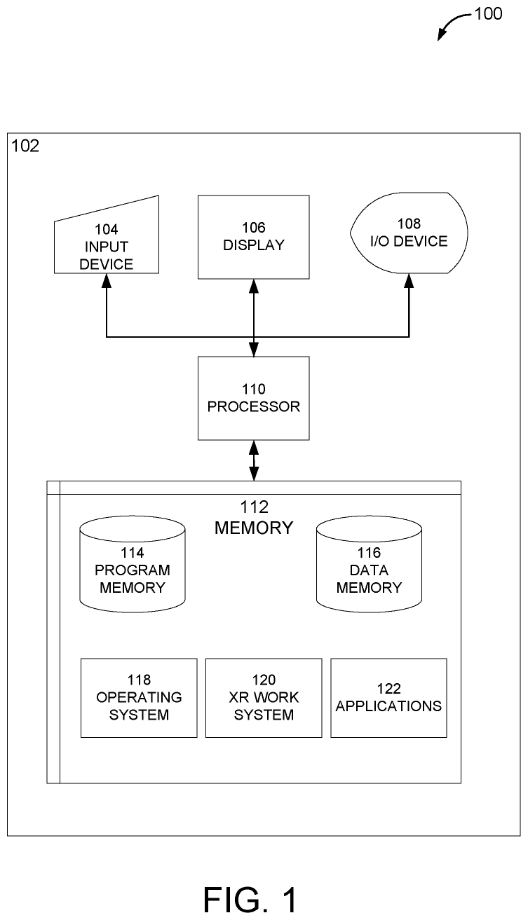

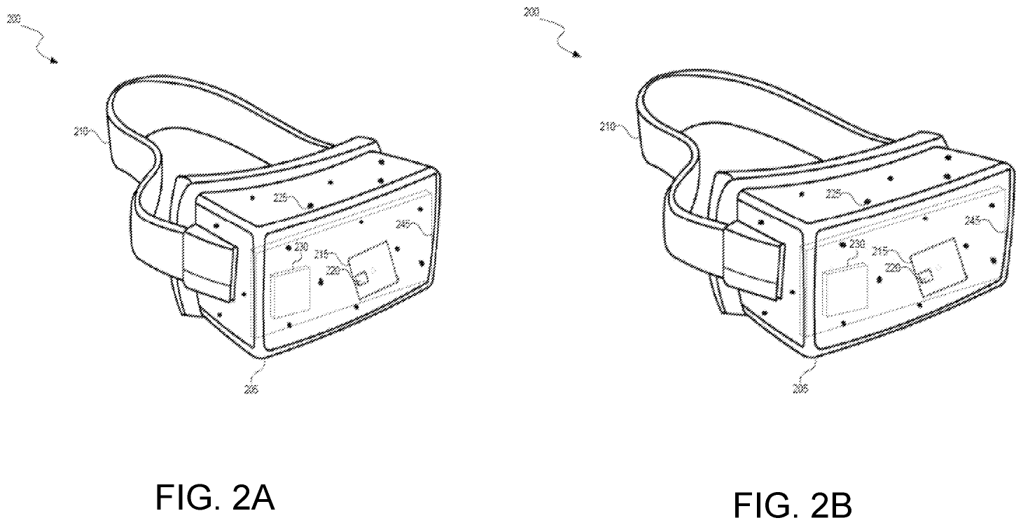

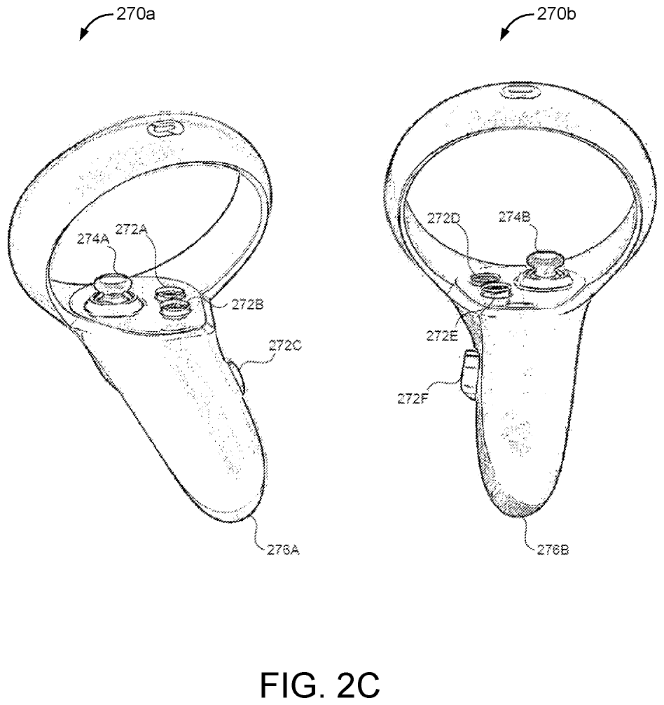

Several implementations are discussed below in more detail in reference to the figures. FIG. 1 is a block diagram of a device operating environment with which aspects of the subject technology can be implemented. The devices can comprise hardware components of a computing system 100 that can create, administer, and provide interaction modes for an artificial reality collaborative working environment. In various implementations, computing system 100 can include a single computing device or multiple computing devices that communicate over wired or wireless channels to distribute processing and share input data. In some implementations, the computing system 100 can include a stand-alone headset capable of providing a computer created or augmented experience for a user without the need for external processing or sensors. In other implementations, the computing system 100 can include multiple computing devices such as a headset and a core processing component (such as a console, mobile device, or server system) where some processing operations are performed on the headset and others are offloaded to the core processing component. Example headsets are described below in relation to FIGS. 2A-2B. In some implementations, position and environment data can be gathered only by sensors incorporated in the headset device, while in other implementations one or more of the non-headset computing devices can include sensor components that can track environment or position data.

The computing system 100 can include one or more processor(s) 110 (e.g., central processing units (CPUs), graphical processing units (GPUs), holographic processing units (HPUs), etc.) The processors 110 can be a single processing unit or multiple processing units in a device or distributed across multiple devices (e.g., distributed across two or more of computing devices).

The computing system 100 can include one or more input devices 104 that provide input to the processors 110, notifying them of actions. The actions can be mediated by a hardware controller that interprets the signals received from the input device and communicates the information to the processors 110 using a communication protocol. Each input device 104 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, and/or other user input devices.

Processors 110 can be coupled to other hardware devices, for example, with the use of an internal or external bus, such as a PCI bus, SCSI bus, wireless connection, and/or the like. The processors 110 can communicate with a hardware controller for devices, such as for a display 106. The display 106 can be used to display text and graphics. In some implementations, display 106 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and/or the like. Other I/O devices 108 can also be coupled to the processor, such as a network chip or card, video chip or card, audio chip or card, USB, firewire or other external device, camera, printer, speakers, CD-ROM drive, DVD drive, disk drive, etc.

The computing system 100 can include a communication device capable of communicating wirelessly or wire-based with other local computing devices or a network node. The communication device can communicate with another device or a server through a network using, for example, TCP/IP protocols. The computing system 100 can utilize the communication device to distribute operations across multiple network devices.

The processors 110 can have access to a memory 112, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. The memory 112 can include program memory 114 that stores programs and software, such as an operating system 118, XR work system 120, and other application programs 122. The memory 112 can also include data memory 116 that can include information to be provided to the program memory 114 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, and/or the like.

FIGS. 2A-2B are diagrams illustrating virtual reality headsets, according to certain aspects of the present disclosure. FIG. 2A is a diagram of a virtual reality head-mounted display (HMD) 200. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real-world and in a virtual environment in three degrees of freedom (3DoF), six degrees of freedom (6DoF), etc. For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real-world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270a-270b, which, in some implementations, a user can hold in one or both hands to interact with an artificial reality environment presented by the HMD 200 and/or HMD 250. The controllers 270a-270b can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers 270a-270b can also include various buttons (e.g., buttons 272A-F) and/or joysticks (e.g., joysticks 274A-B), which a user can actuate to provide input and interact with objects. As discussed below, controllers 270a-270b can also have tips 276A and 276B, which, when in scribe controller mode, can be used as the tip of a writing implement in the artificial reality working environment.

In various implementations, the HMD 200 or 250 can also include additional subsystems, such as an eye tracking unit, an audio system, various network components, etc. To monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions.

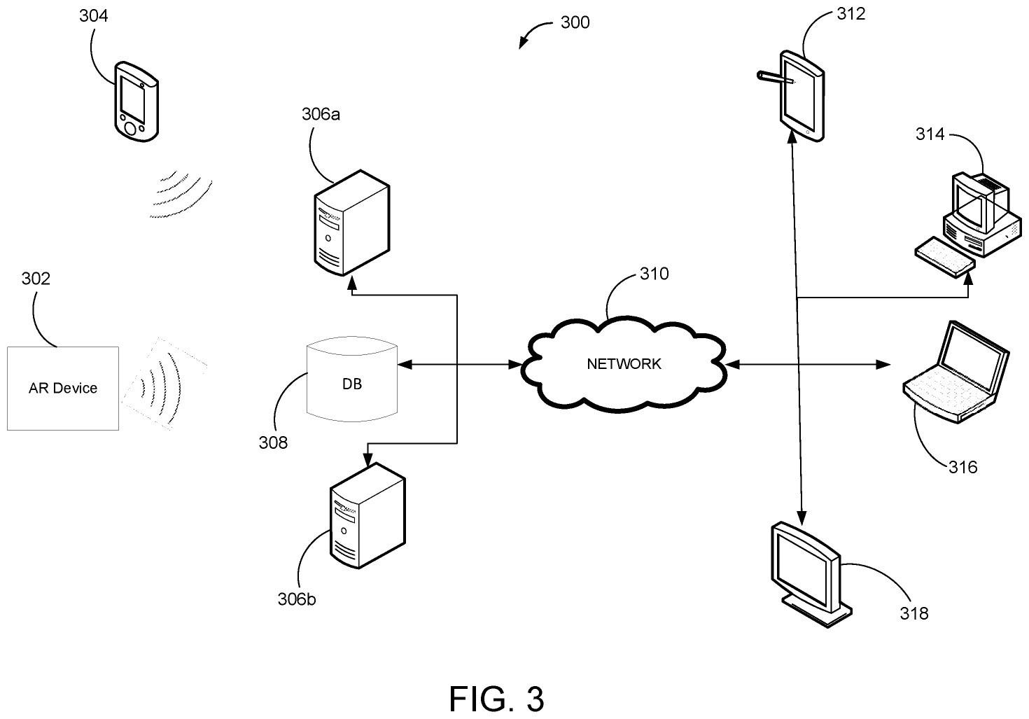

FIG. 3 is a block diagram illustrating an overview of an environment 300 in which some implementations of the disclosed technology can operate. Environment 300 can include one or more client computing devices, such as artificial reality device 302, mobile device 304 tablet 312, personal computer 314, laptop 316, desktop 318, and/or the like. The artificial reality device 302 may be the HMD 200, HMD system 250, or some device that is compatible with rendering or interacting with an artificial reality or virtual reality environment. The artificial reality device 302 and mobile device 304 may communicate wirelessly via the network 310. In some implementations, some of the client computing devices can be the HMD 200 or the HMD system 250. The client computing devices can operate in a networked environment using logical connections through network 310 to one or more remote computers, such as a server computing device.

In some implementations, the environment 300 may include a server such as an edge server which receives client requests and coordinates fulfillment of those requests through other servers. The server may include server computing devices 306a-306b, which may logically form a single server. Alternatively, the server computing devices 306a-306b may each be a distributed computing environment encompassing multiple computing devices located at the same or at geographically disparate physical locations.

The client computing devices and server computing devices 306a-306b can each act as a server or client to other server/client device(s). The server computing devices 306a-306b can connect to a database 308. Each server computing devices 306a-306b can correspond to a group of servers, and each of these servers can share a database or can have their own database. The database 308 may logically form a single unit or may be part of a distributed computing environment encompassing multiple computing devices that are located within their corresponding server, or located at the same or at geographically disparate physical locations.

The network 310 can be a local area network (LAN), a wide area network (WAN), a mesh network, a hybrid network, or other wired or wireless networks. The network 310 may be the Internet or some other public or private network. Client computing devices can be connected to network 310 through a network interface, such as by wired or wireless communication. The connections can be any kind of local, wide area, wired, or wireless network, including the network 310 or a separate public or private network.

In some implementations, the server computing devices 306a-306b can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (via their avatar or true-to-life representation) with objects or other avatars in a virtual environment (e.g., in an artificial reality working environment), etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide a virtual environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

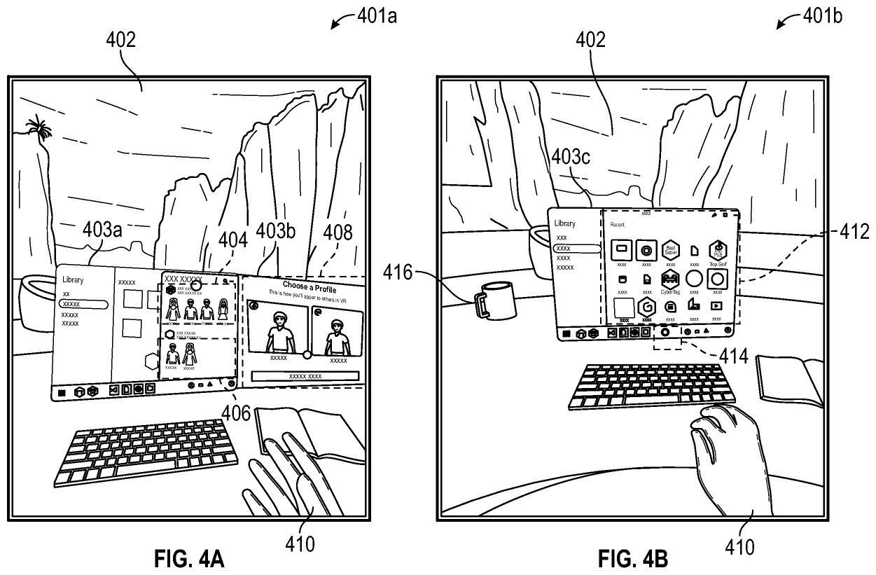

FIGS. 4A-4B illustrate example views of a user interface in artificial reality environments 401a-401b, according to certain aspects of the present disclosure. For example, the artificial reality environment may be a shared artificial reality (AR) environment, a virtual reality (VR), an augmented reality environment, a mixed reality environment, a hybrid reality environment, a non immersive environment, a semi immersive environment, a fully immersive environment, and/or the like. The XR environments 401a-401b may be presented via the HMD 200 and/or HMD 250. For example, the XR environments 401a-401b may include virtual objects such as a keyboard, a book, a computer, and/or the like. The virtual objects can be mapped from real world objects such as a real world office of a user. As an example, the controllers in the mixed reality HMD 252 can convert the image data into light pulses from the projectors in order to cause a real world object such as a coffee cup to appear as a mapped virtual reality (VR) coffee cup object 416 in the XR environment 401b. In this way, as an example, if the user moves the real world coffee cup, motion and position tracking units of the HMD system 250 may cause the user caused movement of the real world coffee cup to be reflected by motion of the VR coffee cup object 416.

The XR environments 401a-401b may include a background 402 selected by the user. For example, the user can select a type of geographic environment such as a canyon, a desert, a forest, an ocean, a glacier and/or the like. Any type of suitable stationary or non-stationary image may be used as the user selected background 402. The XR environments 401a-401b may function as a VR office for the user. The VR office may include user interfaces for selection of parameters associated with the shared XR environment, such as a user interface of a computer virtual object or display screen virtual object. For example, the XR environments 401a-401b may include display screen virtual objects 403a-403c. The display screens 403a-403c can be mixed world objects mapped to a real world display screen, such as a computer screen in the user's real world office. The display screens 403a-403c may render pages or visual interfaces configured for the user to select XR environment parameters. For example, the user may configure the XR environments 401a-401b as a personal workspace that is adapted to user preferences and a level of immersion desired by the user. As an example, the user can select to maintain the user's access to real-world work tools such as the user's computer screen, mouse, keyboard, or to other tracked objects such as a coffee mug virtual object 416 while the while the user is inside the XR environments 401a, 401b. In this way, the user's interactions with a real world coffee mug may be reflected by interaction of a user representation corresponding to the user with the coffee mug virtual object 416.

Also, the XR environments 401a, 401b includes computer display screens 403a-403c that display content, such as on a browser window. The browser window can be used by the user to select AR parameters or elements such as a user representation, a virtual area, immersive tools, and/or the like. For example, the user may select that their user representation should be an avatar, a video representation (e.g., video screen virtual object that shows a picture of the user, another selected picture, a video feed via a real world camera of the user, etc.), or some other suitable user representation. The browser window may be linked to a real world device of the user. As an example, the browser window may be linked to a real world browser window rendered on a real world computer, tablet, phone, or other suitable device of the user. This way, the user's actions on the real world device may be reflected by one or more of the corresponding virtual display screens 403a-403c.

The mixed reality HMD system 250 may include a tracking component (e.g., position sensor, accelerometer, etc.) that tracks a position of the real world device screen, device input (e.g., keyboard), user's hands, and/or the like to determine user commands or instructions input in the real word. The mixed reality HMD system 250 can cause the user input to be reflected and processed in the XR environments 401a-401b. This enables the user to select a user representation for use in the shared XR environment. The selected user representation may be configured for display in various virtual areas of the shared XR environment. The profile selection area 408 may also include options to select how the user should appear during meetings in the shared XR environment. For example, during a meeting in an immersive space between multiple users, the user may select to join via a video representation at a table virtual object. As an example, a video feed of the user linked to a real world camera may be used to display a screen virtual object at a seat virtual object of a conference table virtual object. The user may be able to select options such as switching between various seats at the conference table, panning a view of the user around the virtual area where the meeting occurs, and/or the like. As an example, the user may select an embodied avatar, such as an avatar that appears as a human virtual object.

In this way, the user selected avatar may track the user's real world expressions, such as via the tracking component of the mixed reality HMD system 250. For example, the user's facial expressions (e.g., blinking, looking around, etc.) may be reflected by the avatar. The user may also indicate relationships with other users, so as to make connections between various user representations. For example, the user may indicate through user input which user representations are considered friends or family of the user. The user input may involve dragging and dropping representations of the friends or family via a real world mouse onto a real world display screen, clicking on a real world mouse, using the virtual object controllers 270a-270b, or some other suitable input mechanism. User inputs entered via a real world object may be reflected in the shared XR environment based on the mixed reality HMD system 250. The user may use a user input via a user device (e.g., real world computer, tablet, phone, VR device, etc.) to indicate the appearance of their corresponding user representation in the profile selection area 408 so that other associated user representations recognize the user's user representation. The online or offline status of user representations associated with the user can be shown in the avatar online area 404 of the display screen 403a. For example, the avatar online area 404 can graphically indicate which avatars (e.g., avatars associated with the user's user representation) are online and at what locations.

The user may also use a user input to select a profile for the shared XR environment and/or XR environments 401a-401b on a profile selection area 408 of the display screen 403b. The profile for the user may include workspace preferences for the user, such as a size, color, layout, and/or the like of a home office virtual area for the user. The profile may also include options for the user to add contextual tools such as tools for adding content (e.g., AR content), mixed reality objects, sharing content (e.g., casting) with other users, and/or the like. For example, the profile may specify a number of browser windows and define types or instances of content that the user may select to share with other users. For example, the profile may define types or instances of content that the user selects to persistently exist as virtual objects in the user's personal XR environments 401a-401b. The computer display screen 403c may display a browser window having an application library 412 that the user may use to select AR applications. A representation of a hand of the user, such as hand virtual object 410 may be used to select the AR applications.

Also, a cursor or pointer 414 may be used to select one or more instances of the AR applications in the application library 412. For example, the user may move a real world computer mouse that is linked to the same movement of a computer mouse virtual object by a human hand virtual object in the personal XR environment 401b. Such linking may be achieved by the tracking component of the mixed reality HMD system 250, as described above. As an example, the user may use the virtual object controllers 270a-270b to control the cursor or pointer 414. In this way, the user may select instances of AR applications, which can be represented as graphical icons in the application library 412. For example, the graphical icons can be hexagons, squares, circles, or other suitably shaped graphical icons. The graphical icons that appear in the application library 412 may be sourced from a library of applications, such as based on a subscription, purchase, sharing, and/or the like by the user. As an example, the user may send an indication of a particular AR application to other users (e.g., friends, family, etc.) for sharing, such as to allow the other users to access the particular AR application (e.g., at a particular point), to prompt the other users to access or purchase the application, to send a demo version of the application, and/or the like. The cursor or pointer 414 may be used to indicate or select options displayed on the display screens 403a-403c.

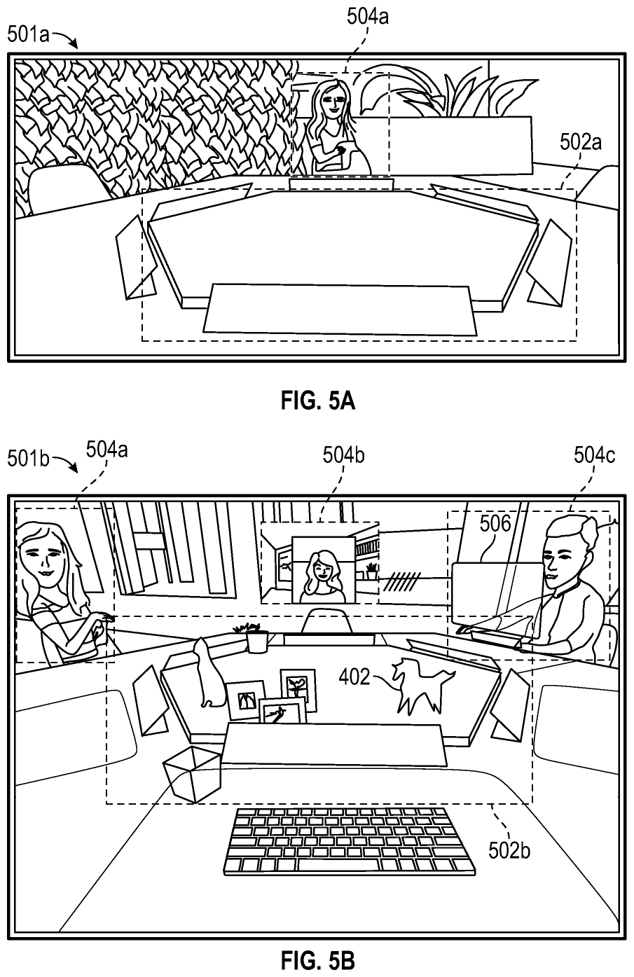

FIGS. 5A-5B illustrate example views of embedding content in a shared XR environment, according to certain aspects of the present disclosure. For example, the XR environments 501a-501b illustrate a virtual area simulating a conference room configuration that includes seat virtual objects and a table virtual object. The table virtual object can comprise a content display area 502a, such as for displaying embedded content from an AR application. As an example, virtual objects (e.g., AR/VR elements) from a selected AR application may be output, displayed, or otherwise shown in the content display area 502a. Various user representations 504a-504c may be seated around the simulated conference room, such as based on appearing at corresponding seat virtual objects around the table virtual object. The user representations 504a-504c may be friends, colleagues, or otherwise related or unrelated, for example. Each of the user representations 504a-504c may appear as an avatar, a video representation (e.g., video screen virtual object that shows a picture of the user, another selected picture, a video feed via a real world camera of the user, etc.), or some other suitable user representation, as selected by each corresponding user. The user representations 504a-504c can be located around the table virtual object for a work meeting, presentation, or some other collaborative reason.

The content display area 502a may be used as a presentation stage so that content may be shared and viewed by all of the user representations. For example, the content display area 502a may be activated such that content is displayed at content display area 502b. In content display area 502b, AR/VR content may be embedded onto a surface of the content display area 502b, such as a horse virtual object 402 and other virtual objects such as a dog and picture frame virtual objects. The embedded content may be sourced from a selected artificial reality application, a common data storage area, a system rendered AR component, a user's personal content storage, a shared user content storage, and/or the like. As an example, the embedded content displayed in the content display area 502b can be from an AR application. The user may select an AR application as well as a portion of the selected AR application from which the embedded content should be sourced. As an example, the AR application may be a home design app in which specific types of design elements such as picture frames and animal structures may be configured and shared. This way, the design elements such as the horse virtual object 402 may be output onto the content display area 502b and shared with others (e.g., users/user representations associated with the user).

The embedded content from the selected AR application may be static or dynamic. That is, the embedded content can derive from a screenshot of the AR application or it can be updated as user representations are engaged in the AR application. For example, the home design app may allow a user/user interaction to interact with various design elements and this dynamic user-design element interaction may be reflected and displayed at the content display area 502b. As an example, the content embedded at the content display area 502b may be a miniature version of one or more AR applications that are being executed. The AR applications may be private or public (e.g., shared). The content being embedded may be derived from one or more private AR applications, one or more public AR applications, or a combination thereof. In this way, content from various AR applications may be shared into a shared AR/VR space represented by the content display area 502b. Also, the embedded content may be shared from other AR/VR sources other than specific AR applications, such as repositories of virtual objects or elements, AR/VR data storage elements, external AR/VR compatible devices, and/or the like.

The embedded content shown in the content display area 502b may form, constitute, or include links. The links may be deep links, contextual links, deep contextual links, and/or the like. For example, the horse virtual object 402 may comprise a deep link that causes the home design AR app to load for a user/user representation that activates the deep link. As an example, if the home design AR app is not purchased, the user/user representation that activated the deep link may be prompted to download the home design AR app, purchase the app, try a demo version of the app, and/or the like. The deep link may refer to opening, rendering, or loading the corresponding embedded content or link in the linked AR application (or linked AR/VR element). If a link is contextual, this may refer to activation of the link causing activation of the corresponding linked AR/VR element at a particular layer, portion, or level. For example, the horse virtual object 402 may comprise a deep contextual link created by a friend of the user such that when the user activates the deep contextual link, the user is automatically transitioned to a portion of the home design AR app where the friend's user representation is currently located.

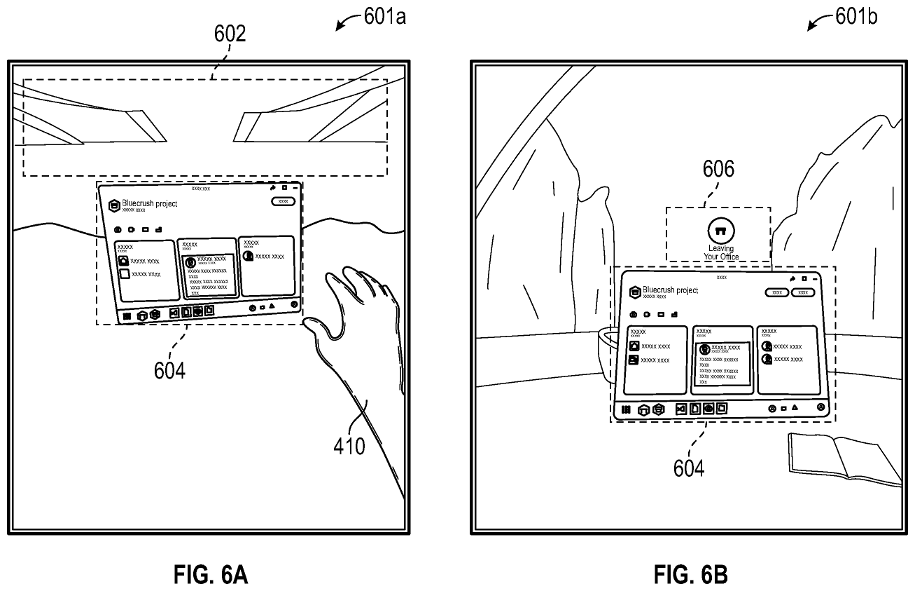

FIGS. 6A-6B illustrate example views of XR environments 601a-601b for selecting a destination area of a shared XR environment, according to certain aspects of the present disclosure. Selection of the destination area may cause a user to travel or transition from one virtual area to another virtual area of the shared XR environment. The transition or indication may be indicated to the user, such as based on an indication 602 (e.g., visual indication, audio indication, etc.) to the user. For example, a blue light visual indication or other colored visual indication 602 may appear to be proximate to the user's user representation when travel is activated or occurring. The blue light visual indication 602 may be temporary such that it fades away from the rendered XR environment once a destination AR/VR space finishes loading. Travel between virtual areas can involve latency. The computing system 100 or other suitable AR server/device that renders or hosts the shared XR environment may apply a filter to alter latency perception of the user/user representation while travel is occurring. The filter may be applied to hide latency associated with loading a destination virtual area, selected AR application, associated audio element, associated video elements, and/or the like.

As an example, the computing system 100 or other suitable AR server/device can cause the user/user representation to perceive a preview of the destination virtual area or AR application while the destination is loading. As an example, a static screen shot, an audio preview, a visual preview and/or the like can be generated for the user representation while there is latency in loading the destination virtual area or selected AR/VR element. The audio preview may include audio elements that enable the user representation to audibly hear or perceive the audible or verbal activity of other associated user representations (e.g., friends or family). The visual previous may include visual elements that enable the user representation to see the visually perceptible activity of the other associated user representations. A user may use an AR home screen 604 to control settings (e.g., user settings, VR/AR settings, etc.) associated with the XR environment and to select destination virtual areas or spaces in the shared XR environment such as the destination virtual area corresponding to XR environment 601a. For example, the destination virtual area corresponding to XR environment 601a may be a shared collaborative work space or virtual meeting space labeled “Bluecrush Project.” The AR home screen 604 can also include or indicate information such as events, social media posts, updates, and/or the like that is associated with the Bluecrush Project or other selected destination virtual areas. Other information that is selected by or relevant to the user may also be included on the AR home screen 604.

The user may use a user input mechanism (e.g., cursor or pointer 414, controllers 270a-270b, hand 410, etc.) to control, navigate, and/or select portions of the AR home screen 604. For example, the user may use their hand 410 to select or otherwise indicate the destination virtual area. As an example, the user may use their hand 410 to indicate that the user desires to leave an origin virtual area (e.g., the user's office, etc.) to a destination virtual area (e.g., the Bluecrush Project virtual space). Travel may be performed between a private virtual area and a public virtual area. For example, the user's office may be a private virtual space created for the user and the Bluecrush Project virtual space may be a shared public virtual space. Traveling or transitioning through the shared artificial environment may be tracked by a transition indication 606. For example, the transition indication may be an audio indication, a visual indication, a movement of a three dimensional object file, an interaction of an avatar with another virtual area, a screenshot, a loading window, and/or the like. As an example, the transition indication 606 shown in XR environments 601b indicates that the user is leaving their office. The transition indication 606 can be followed by or precede blue light visual indication 602. Both indicators may be preceded by the destination virtual area loading for the user's VR/AR compatible device.

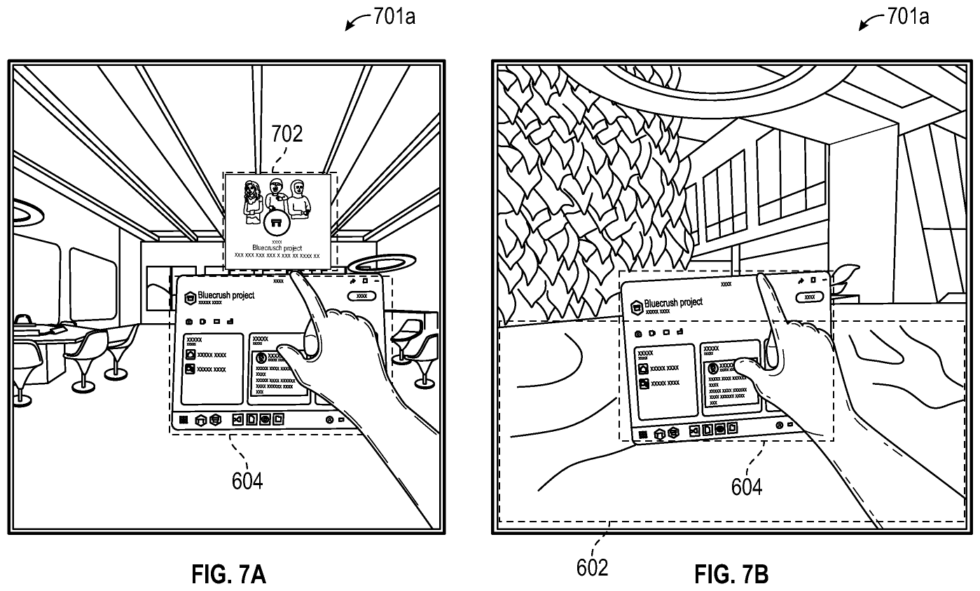

FIGS. 7A-7B illustrate example views of XR environments 701a-701b for selecting a destination area of a shared XR environment, according to certain aspects of the present disclosure. As discussed above, selection of the destination area may cause a user to travel or transition from an origin virtual area to a destination virtual area of the shared XR environment. Similarly to the transition indication 606, the transition indication 702 may indicate that the user is leaving the Bluecrush Project shared collaborative virtual space. The transition indication 702 may be displayed above the AR home screen 604 as shown in the XR environment 701a. The transition indication 702 may comprise visual indicators of user representations associated with the user representation corresponding to the user. The associated user representations may be colleagues, friends, family, user selected user representations and/or the like. The associated user representations may be displayed as their corresponding avatars in the transition indication 702.

While the transition indication 702 is displayed and/or while the user representation corresponding to the user is traveling, the user/user representation may receive an audio element indicative of the associated user representations in one or more other virtual areas of the shared XR environment. For example, the audio element may be provided to the user's AR/VR compatible device to indicate activity or engagement of associated user representations in the shared XR environment. As an example, the audio element may indicate audible indications of activity for each associated user representation in a corresponding AR application or AR/VR space. The associated user representations could all be located in the same part of the shared XR environment such as all playing in the same AR game application. The audio element can be segmented into different audio channels so that the user may hear all of the associated user representations simultaneously. Alternatively, the user may select or choose a subset of the audio channels to control which user representations of the associated user representations are heard via the provided audio element.

A default setting may specify that the user hears all the associated user representations that are located in the original virtual area. Also, the user may select to hear all user representations that are located in the original virtual area, regardless of whether the user representations are associated or not. Similarly, a visual element may be provided to the user's AR/VR compatible device to visually indicate activity or engagement of associated user representations in the shared XR environment. Activity or engagement of associated user representations and other non-associated user representations can be visually displayed if the other user representations are located in the same destination area as the user's user representation in the shared XR environment. For example, user representations located in the same virtual area/destination may be shown as avatars on a display screen rendered by the user's AR/VR compatible device for the user representation or on the transition indication 702.

Moreover, the transition indication 702 may include an immersive screenshot (e.g., a live screenshot of the destination virtual area, a non-dynamic screenshot of the destination, a picture of an aspect of the shared XR environment associated with the destination, etc.), a loading window showing an aspect of the destination, and/or some other indication of the selected user representations. The transition indication 702 can also involve providing a three hundred sixty degree preview of the destination virtual area while the user representation is traveling to the destination. The three hundred sixty degree preview may be a blurred preview until loading is complete, for example. As an example, the preview of the transition indication 702 may show who (e.g., what user representations, non-user AR elements, etc.) is going to be in the destination virtual area before the destination loads.

In this way, the user representation may advantageously remain connected to other user representations in the shared XR environment (e.g., via the audio or visual elements of the provided transition indication 702) even while the user representation is traveling or transitioning throughout the shared XR environment. As an example, the audio element may be provided to the user representation prior to loading the visual element and/or a visual component of the destination virtual area. That is, the user/user representation can hear the destination virtual area prior to loading the visual component (e.g., the audio element can audibly represent the activity of user representations located in the destination virtual area). For example, the audio element of the transition indication 702 may enable the audible simulations of virtual areas other than the one that the user representation is currently located in and may enable more smooth transitions between virtual areas (e.g., by providing audio components to the user prior to visual components). As discussed above, the transition indication 702 may be accompanied by, preceded by, or followed by a blue light visual indication 604. The blue light visual indication 604 may represent that the user representation is in the process of transitioning from the original virtual area to the destination virtual area.

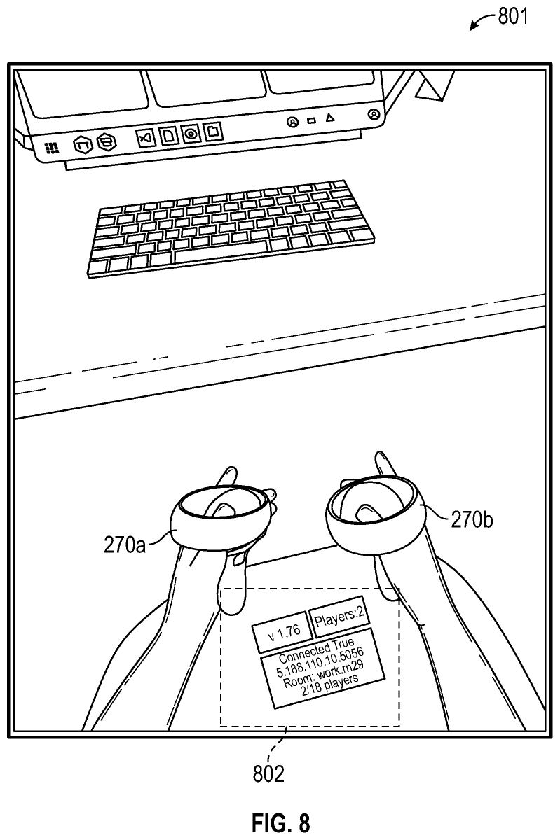

FIG. 8 illustrates interaction with an AR application in a shared XR environment according to certain aspects of the present disclosure. The XR environment 801 shows a user being connected to and engaged in the AR application, as reflected by the information screen 802. The user may use a user input mechanism (e.g., controller 270a-270b, etc.) to interact with the AR application. The user can have used a navigation element such as the AR home screen 604 to select the AR application. As an example, the AR application can be a game that the user representation can engage in individually or in conjunction with other user representations (e.g., associated user representations). As discussed above, audio elements and/or visual elements indicative of the progress of user representations that are selected by or associate with user representation may be provided to the user representation. In this way, the user/user representation may remain connected to other user representations while being engaged in the shared XR environment. As an example, the user representation may visually see or hear a friendly user representation even if not located in the same virtual area as the friendly user representation. For example, the computing system 100 or other suitable AR server/device may cause display of the friendly user representation (e.g., avatar) to the user representation via a visual component of the user's AR/VR compatible user device.

For example, the computing system 100 or other suitable AR server/device may cause output of the sounds associated with activity of the friendly user representation to the user representation via an audio component of the user's AR/VR compatible user device. As an example, the user representation may be located in an AR application store virtual area of the shared XR environment. In the AR application store, the user/user representation may still be able to hear the friendly user representation and other friends engaged in the selected AR application. This way, the user/user representation may hear their friends playing the selected AR application or engaged in other aspects of the shared XR environment before the user representation joins the friends. Moreover, when the user is engaged in the selected AR application, the computing system 100 or other suitable AR server/device may send an audio element (e.g., audio associated with execution of the AR application) and/or a visual element to selected user representations or user representations associated with the user representation. Prior to or while the user is engaged in the selected AR application, the information screen 802 may indicate information associated with the AR application. For example, the information screen 802 may indicate that the version of the AR application is version 1.76, that two players are currently playing the AR application, and that the user representation is playing with address 5.188.110.10.5056 in playing room “work.rn29” that has a capacity of eighteen players.

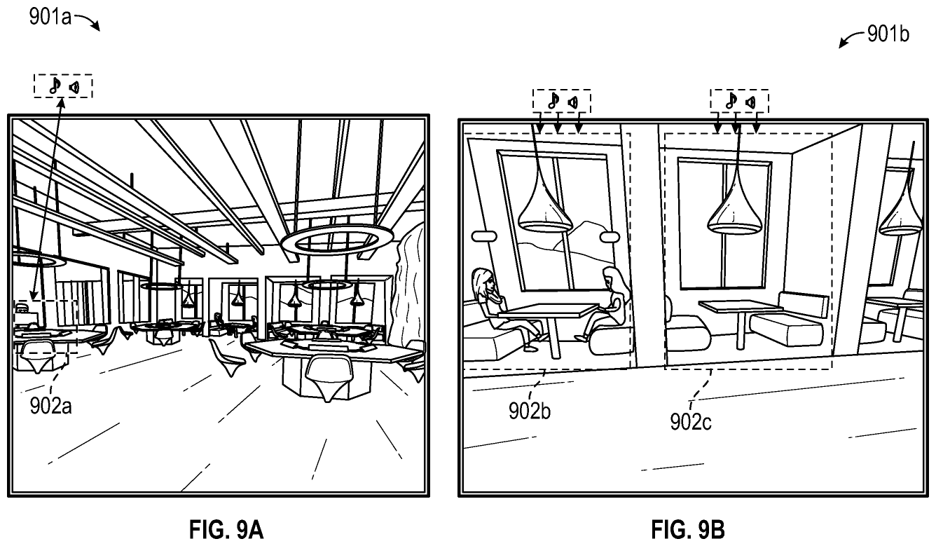

FIGS. 9A-9B illustrate example views of applying audio elements in areas of an artificial reality environment, according to certain aspects of the present disclosure. The audio elements may be audio indications that are generated for user representations that are associated with each other, user representations that are in proximity of each other, user representations in proximity of an audio zone, user representations that are selected to be in a group, and/or the like. The XR environments 901a-901b illustrate the presence of audio zones 902a-902c in which sound or audio is adjusted to simulate a real world audio environment. For example, the audio zone 902a may simulate a conference table setting. Various user representations may be assigned or select seat virtual objects around a conference table virtual object. The various user representations may be considered in the same audio zone 902a such that audio sources inside the audio zone 902a are emphasized and/or audio sources outside of the audio zone 902a are deemphasized. Similarly, the XR environment 901b depicts audio zones 902b-902c. As an example, the audio zones 902b-902c may simulate adjacent booths at a public working space such as an office work space, a coffee shop workspace, and/or the like. For example, the public working space may comprise multiple user representations seated across or around each other on bench virtual objects.

For the multiple user representations, audio sources inside the audio zones 902b-902c can be emphasized and/or audio sources outside of the audio zones 902b-902c can be deemphasized. For example, sound emphasis may be added or removed based on sound adjustment, such as sound amplification, sound muffling, sound dampening, sound reflection and/or the like. As an example, the sound adjustment may include muffling or dampening distracting audio sources by the computing system 100 or other suitable AR server/device for each AR/VR connected device corresponding to user representations in the audio zones 902b-902c. Any audio source outside of the audio zones 902b-902c may be considered distracting and subject to muffling or dampening. Alternatively, a subset of audio sources outside of the audio zones 902b-902c may be considered distracting based on criteria such as type of audio source, audio content, distance of audio source from the audio zone, and/or the like. Also, the distracting audio may be reflected outwards (e.g., away from the audio zones 902b-902c). As an example, virtual sound waves may be modeled by the computing system 100 or other suitable AR server/device and cast or otherwise propagated in a direction facing away from the audio zones 902b-902c. In this way, the audio zones 902b-902c may be insulated from some undesired external sounds.

Conversely, the virtual sound waves from audio sources within the audio zones 902b-902c) may be propagated towards the audio zones 902b-902c, such as towards the user representations sitting around a table virtual object. For example, the virtual sound waves corresponding to conversation of the multiple user representations may be amplified and/or reflected inwards towards a center of the audio zones 902a-902c (e.g., which may correspond to a conference table simulation and a booth simulation, respectively). Other virtual sound waves that are directed towards one or more the audio zones 902a-902c may be characterized and adjusted in terms of its sound based on this characterization. For example, a virtual sound wave corresponding to speech from a first user representation located outside of the audio zones 902c and associated (e.g., as a friend) with a second user representation may be amplified and/or reflected towards the audio zone 902c. This type of virtual sound adjustment may be performed for each user representation individually so that sounds that are determined to be pertinent for each user representation are adjusted correctly. In this way, each user representation would not hear amplified sound from unassociated user representations or otherwise undesirable audio sources. The sound adjustment settings may be selected via an appropriate user input for each user/user representation. As an example, each user may select types of audio that are desired to be amplified, dampened, or otherwise modified in sound.

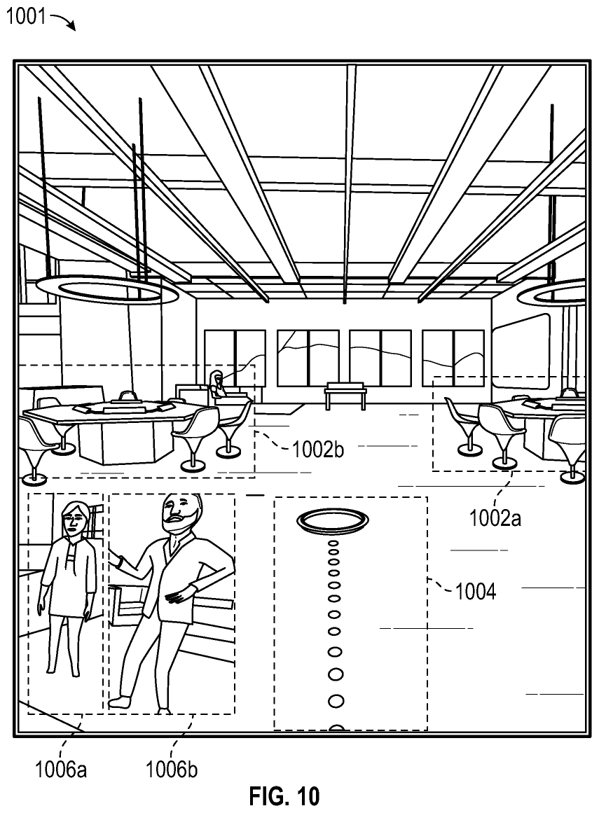

FIG. 10 illustrates an example view of an AR collaborative working environment, according to certain aspects of the present disclosure. The AR collaborative working environment may be a shared AR workspace 1001 hosted by a company, for example. The shared AR workspace 1001 can comprise virtual objects or formats that mimic real world elements of a real world project space, such as chair virtual objects, conference table virtual objects, presentation surface virtual objects, presentation surfaces (e.g., whiteboards or screens that various user representations can cast content to and/or from virtual or real world devices, etc.), notes (e.g., sticky note virtual object, etc.), desk virtual objects. In this way, the AR workspace 1001 may be configured to accommodate various virtual workspace scenarios, such as ambient desk presence, small meetings, large events, third person experiences, and/or the like.

The AR workspace 1001 may include conference areas 1002a-1002b that have chair virtual objects around a conference table virtual object. Various user representations may join the conference areas 1002a-1002b by selecting a chair virtual object. A private permission may be required to be granted for a particular user representation to join the conference areas 1002a-1002b or the conference areas 1002a-1002b may be publically accessible. For example, the particular user representation may need a security token or credential associated with their corresponding VR/AR device to join the conference areas 1002a-1002b. A user may use a user input mechanism (e.g., cursor or pointer 414, controllers 270a-270b, hand 410, etc.) to instruct their corresponding user representation to move throughout the shared AR workspace 1001. For example, the user may hold and move the controllers 270a-270b to control their user representation.

The shared AR workspace 1001 may illustrate traveling by a user representation corresponding to the user throughout a shared XR environment having multiple user representations. The controlled movement of their user representation may be indicated by the movement indicator 1004. The movement indicator 1004 can comprise a circular destination component to indicate where the user representation is instructed to move and a dotted line component to indicate the direction that the user representation is instructed to move. The movement indicator 1004 can also be or include other suitable indicators that inform the user of how to move in the shared AR workspace 1001. As the user travels throughout the shared XR environment, the user representation may receive indications of a presence of other user representations around the destination. For example, the user device corresponding to the user representation may output a screenshot, visual indication, a screenshot, a loading window, and/or the like that indicates which user representations are in the AR workspace 1001 when the user representation travels there. The output presence indications may indicate all user representations in a destination or only the user representations that are associated with the user's user representation. As discussed above, audio elements and visual elements may be provided by the computing system 100 or other suitable AR server/device so that each user representations remains in communication/connected to other user representations (e.g., associated user representations). As an example, a graphical representation of information being shared by the user representation with another user representation at the destination may be visually represented by a three dimensional file moving along with the movement indicator 1004.

As discussed above, a format of a user representation may be selected by each user in the shared AR collaborative working environment. As an example, the user may select one of multiple avatars such as the female avatar 1006a, the male avatar 1006b, or some other suitable avatar or user representation. The user may customize the appearance of their user representation, such as by selecting clothes, expressions, personal features, and/or the like. As an example, the female avatar 606a is selected to have brown hair and wear a brown one piece of clothing. As an example, the male avatar 606b is selected to have a beard and wear a suit. In this way, the user may use a user input to select characteristics defining how their user representations appears in the shared XR environment.

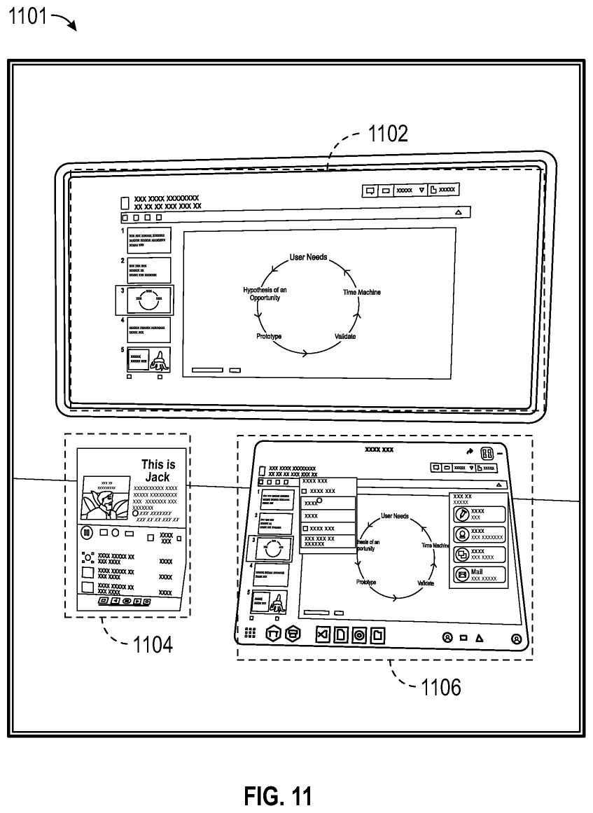

FIG. 11 illustrates example views of an XR environment 1101 for casting content from a first source to a second source in a shared XR environment, according to certain aspects of the present disclosure. For example, the first source may be a user home display screen 1106 and the second source may be a shared presentation display screen 1102. Casting content may refer to screen casting, mirroring, or sharing such that content that is displayed or output on one display (e.g., first source, user home display screen 1106, etc.) or AR/VR area is copied by causing display or output of the same content on another display (e.g., second source, shared presentation display screen 1102, etc.) or another AR/VR area. That is, a user may select to cast content from a first virtual area to a second virtual area in the shared XR environment. As an example, the user or user's user representation may share content on a private screen (e.g., user home display screen 1106) to a public or shared screen (e.g., shared presentation display screen 1102). In this way, other users or user representations may view the shared screen and view the casted content.

The content being cast by the user can be AR/VR content, a file (e.g., image file, object file, etc.), data, a link (e.g., deep link, contextual link, etc.), an AR/VR application, an AR/VR space, and/or the like. As an example, the user may cast a link to an AR application that the user's user representation is currently engaged in. More specifically, the user can cast a specific contextual deep link to the AR application. The user representation may share or cast a portion, layer, view, and/or the like to other selected recipient user representations. As an example, the user representation may cast a first person view of a location within the AR application. The casted first person view may be viewed by recipient user representations even if the recipients are not currently located in the same AR application (e.g., the recipients are in a different virtual area of the shared XR environment). When recipient user representations activate the casted contextual deep link, the deep link may cause the subject recipient user representation to activate or load the corresponding AR application. That is, the portion (e.g., layer, view, level, etc.) of the corresponding AR application referenced by the link can automatically load for the subject recipient user representation. If the subject recipient user representation has not yet downloaded or purchased the corresponding AR application, then the subject recipient user representation may receive an external prompt to download the corresponding AR application.

For example, an online VR display screen may prompt the subject recipient user representation to download or purchase the corresponding AR application and/or transition the subject recipient user representation to an AR application store virtual area of the shared XR environment. The casting may be performed across AR applications. For example, a sender user representation may cast content or a link of an inner lawyer of a particular AR application such that a recipient user representation currently located in an outer layer (e.g., or external to the application) of the particular AR application may be directly transported or transitioned into the inner. In this way, the recipient user representation may travel between different AR applications. Casting may be performed via a selection on a particular user's VR/AR headset. For example, the HMD 200 and/or HMD 250 may have a button or other user input for selecting a casting function. The user/user representation may also cast specific user preference associated with content. For example, the user representation may share a liked song, favorite song, favorite artist, selected playlist, selected album and/or the like from a music display screen 1104 that is open for the user representation. As an example, the music display screen 1104 may be a layer or portion of a streaming music AR application in which the user representation may load a playlist for artist Claude Debussy and share this playlist as content being casted to the recipient user representation.

When casted content is sent to a selected recipient user representation, an indication of the casting process may be displayed for the sender user representation. For example, a three dimensional object file may be displayed in the shared XR environment that represents the musical content being cast by the sender user representation. As an example, if the sender user representation travels from a first virtual area to another virtual area in the shared XR environment, the three dimensional object file may travel as well (e.g., the object file can be a graphical icon that moves in the shared XR environment with the sender user representation, etc.). Casting may be done to facilitate sharing content across the shared XR environment. For example, the user representation may cast content from an AR/VR compatible device such as a presentation hosted by a user device (e.g., powerpoint presentation accessed on laptop that corresponds to user home display screen 1106) to a virtual area of the shared XR environment. The user home display screen 1106 may be screen cast from the screen of the user's laptop user device. The shared presentation display screen 1102 may then be a shared virtual display area that reflects the screen content being cast from the user home display screen 1106. The casted content on the shared presentation display screen 1102 can be the same content as shown on the user home display screen 1106 but at the same, lower (e.g., downscaling resolution), or higher resolution (e.g., upscaling resolution).

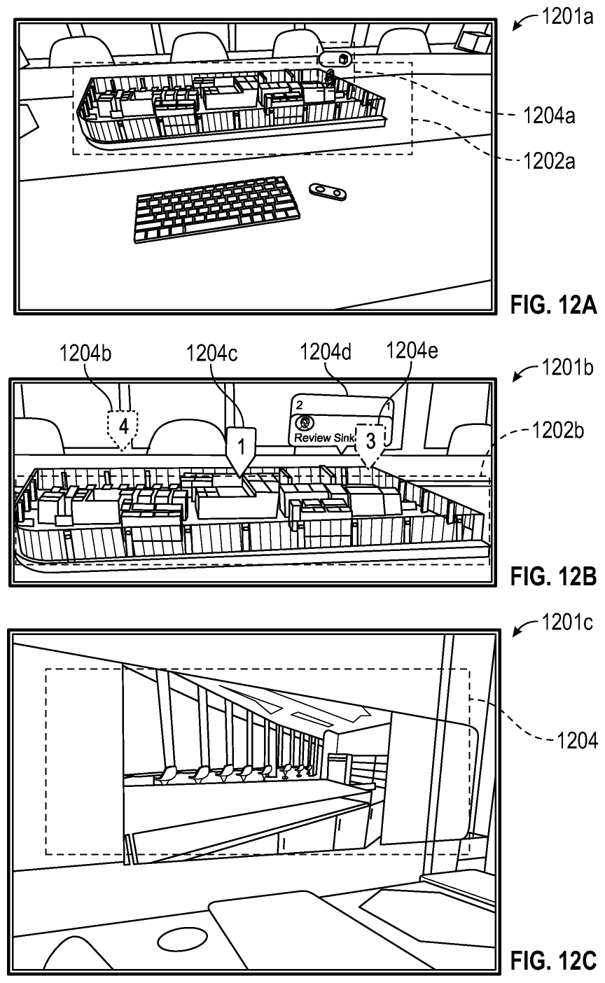

FIGS. 12A-12C illustrate example views of embedding visual content from an AR application into a virtual area of a shared XR environment, according to certain aspects of the present disclosure. The virtual area may be a simulated shared conference room setting represented by the XR environments 1201a-1201c. The conference room setting may comprise a conference table virtual object surrounded by a multiple chair virtual objects. Various user representations can be seated around the table on the chair virtual objects. The conference table virtual object can be a source for embedded visual content. For example, the center of the conference table virtual object can be an embedded content display area. In the XR environment 1201a, visual content such as a miniature map 1202a from an AR application may be embedded in the embedded content display area. For example, the miniature map 1202a may be a labyrinth, a user created virtual space, a home location of an architectural AR application, and/or the like.

As an example, the miniature map 1202 may represent a miniature version of the AR application. This way, the miniature map 1202 can include embedded content from execution of the AR application such that the embedded AR application content can be shared with other representations via the embedded content display area of the conference table virtual object. For example, for the architectural AR application, the embedded content may be an architectural floor plan created via the architectural AR application by the user. In this situation, the user's user representation may share the created architectural floor plan with other user representations. The created architectural floor plan may be represented and manipulated (e.g., selectable and movable by user input about the shared XR environment) so that the user representation can control how to display, change, show, etc. the embedded content. The miniature map 1202a may include an indication of the user representations that are currently located in a corresponding portion of the AR application. For example, a location of a user representation corresponding to user A in an architecture plan designed using the architectural AR application can be indicated by AR application status indicator 1204a.

The AR application status indicator 1204a may be used as a representation of the spatial status (e.g., location within application) of any associated user representations. As shown in the XR environments 1201b, the status of other user representations, location markers, annotative messages, and/or the like may be represented by the miniature map 1202b. For example, AR application status indicators 1204b-1204c may represent a current location of certain user representations. Each of the certain user representations can be associated with the user representation, such as based on being friends, colleagues, family and/or the like. The AR application status indicators 1204b-1204c may be color coded such that the AR application status indicator 1204b is pink and represents user representation B, the AR application status indicator 1204c is yellow and represents user representation C, and the AR application status indicator 1204b is blue and represents user representation D. The application status indicators 1204b-1204d may track and indicate the locations of user representations A-C as they move through the AR application, respectively.

The AR application status indicator 1204d can indicate a message about an aspect of the AR application. The message can be system generated or user generated. For example, a user E may have used a user input mechanism (e.g., cursor or pointer 414, controllers 270a-270b, hand 410, etc.) to specify a message indicating that a kitchen sink should be reviewed later. To elaborate further, the kitchen sink may be part of a floor plan generated via the architectural AR application and may correspond to a real word sink that requires repairs. Each of the application status indicators 1204a-1204e may also constitute a link, such as a deep contextual link. As an example, if the user uses the user input mechanism to click on or select one of the application status indicators 1204a-1204e, the user's user representation may be automatically transported or transitioned to the same location as the application status indicators 1204a-1204e. In this way, the shared XR environment may provided content linking that facilitates or improves the speed at which the user representation may travel or communicate through the shared XR environment. That is, the deep contextual link of the miniature map 1202a-1202b may advantageously improve connectivity between use representations within the computer generated shared XR environment.

As discussed above, the miniature map 1202a-1202b may include or embedded content embedded for display at the embedded content display area of the conference table virtual object. Some or all of the content of the miniature map 1202a-1202b output at the embedded content display area can also be cast to a different virtual area, such as for sharing with other users/user representations. For example, the simulated shared conference room setting may comprise a shared conference display screen 1204 (e.g., which may be similar to the shared presentation display screen 1102) from which various user representations may cast content. Permission, such as by validating security credentials being provided, may be required prior to enabling casting content to the shared conference display screen 1204. As shown in the XR environment 1201a, a portion of the miniature map 1202a-1202b can be cast to the shared conference display screen 1204. As an example, a marked, annotated, and/or otherwise indicated portion of the floor plan generated via the architectural AR application can be cast based on an instruction from the user representation.

A first person view from the user representation or from the other user representations corresponding to one or more of the application status indicators 1204a-1204e may also be cast to the hared conference display screen 1204. This may improve communication and/or the simulated real work aspect of the shared XR environment by enabling various representations to share their current vantage point from their current location in the shared XR environment. Thus, if the user representation is standing in the floor plan represented by the miniature map 1202a-1202b, the user representation can share what is currently being viewed in the corresponding virtual area of the architectural AR application (or other AR/VR application) with other users/user representations.

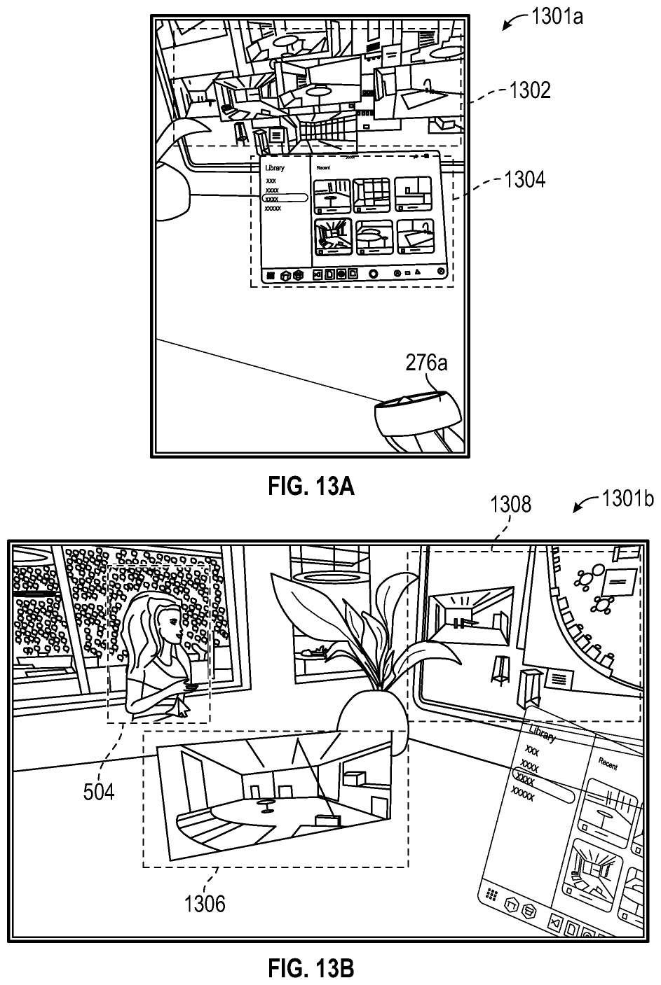

FIG. 13A-13B illustrate sharing content via a user representation in a shared artificial reality environment, according to certain aspects of the present disclosure. The XR environments 1301a-1301b illustrate sharing data or information from a user/user representation to another user/user representation. The data or information may be an image file, AR/VR application, document file, data file, link (e.g., link to application, content, data repository), reference, and/or the like. The data or information being shared may be represented by a graphical icon, thumbnail, three dimensional object file, and/or some other suitable visual element. For example, the data sharing home screen 1304 rendered for the user visually indicates data or information available for file transfer or sharing based on a plurality of image file icons. The user input mechanism (e.g., cursor or pointer 414, controllers 270a-270b, hand 410, etc.) can be used by the user to select, toggle between, maneuver between, etc. the various image file icons for previewing, file sharing, casting, and/or the like.

As an example, a preview of the image corresponding to one of the image file icons can be viewed on the display screen 1302. Also, the user may cast one or more of the images corresponding to the image file icons to the display screen 1302. For example, the image file icons may be image panels that are transferred to the shared display screen 1302 during a meeting attended by multiple user representations. The transferred image file icons also may be configured as links that are selectable by other user representations. The configured links may cause the referenced image file stored on a memory device of the user's VR/AR compatible headset (e.g., HMD 200) to be transferred to the VR/AR compatible headset corresponding to another user representation that selects one of the configured links. Alternatively, the configured links may cause the data referenced by the configured links to be stored to a preselected destination (e.g., a cloud storage location, common network storage, etc. etc.), referenced by a remote storage system, or downloaded from the remote storage system.

The plurality of image file icons may comprise selectable two dimensional links listed on the data sharing home screen 1304. If more than one image is selected, the display screen 1302 may be segmented or organized so that multiple images are displayed simultaneously in a desired layout. A desired layout may be selected from multiple options presented by the computing system 100 or other suitable AR server/device or may be manually specified by the user. As shown in the XR environment 1301a, the user representation may use the tip 276a of the controller 270a to control a cursor that enables interaction with the data sharing home screen 1304. As an example, the user representation may use the controller 270a to select one of the image file icons for previewing, file sharing, casting, and/or the like. The XR environment 1301b shows how the user representation may use the controller 270a to convert a selected image file icon 1306 of the plurality of image file icons from two dimensional format to a three dimensional format. When the cursor controlled by the controller 270a is used to drag the selected image file icon 1306 away from its two dimensional representation in the data sharing home screen 1304, this may cause the selected image file icon 1306 to expand into three dimensional format. Alternatively, the user representation may be prompted to verify whether the selected image file icon 1306 should be converted into three dimensional format.

The XR environment 1301b illustrates that the use representation may control the selected image file icon 1306 for direct sharing with another user representation 504. The another user representation 504 may be an associated user representation that is a friend, family member, or colleague of the user representation. As an example, the selected image file icon 1306 may be a two dimensional or three dimensional rendering of a home kitchen created via an architectural AR application. The display screen 1308 may include the selected image file icon 1306 and other images or files accessible to the user representation or shared publically to multiple user representations in the XR environment 1301b. The another user representation 504 may receive the selected image file icon 1306 as a file transfer to their corresponding AR/VR compatible device. As an example, when the user representation initiates the data transfer with the another user representation 504, the selected image file icon 1306 may be directly downloaded, downloaded from a third party location, or received as a link/reference. As an example, the data transfer may cause the selected image file icon 1306 to be downloaded to local storage of an AR/VR headset corresponding to the another user representations or may cause a prompt to download the selected image file icon 1306 to be received by some other designated computing device or other device.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

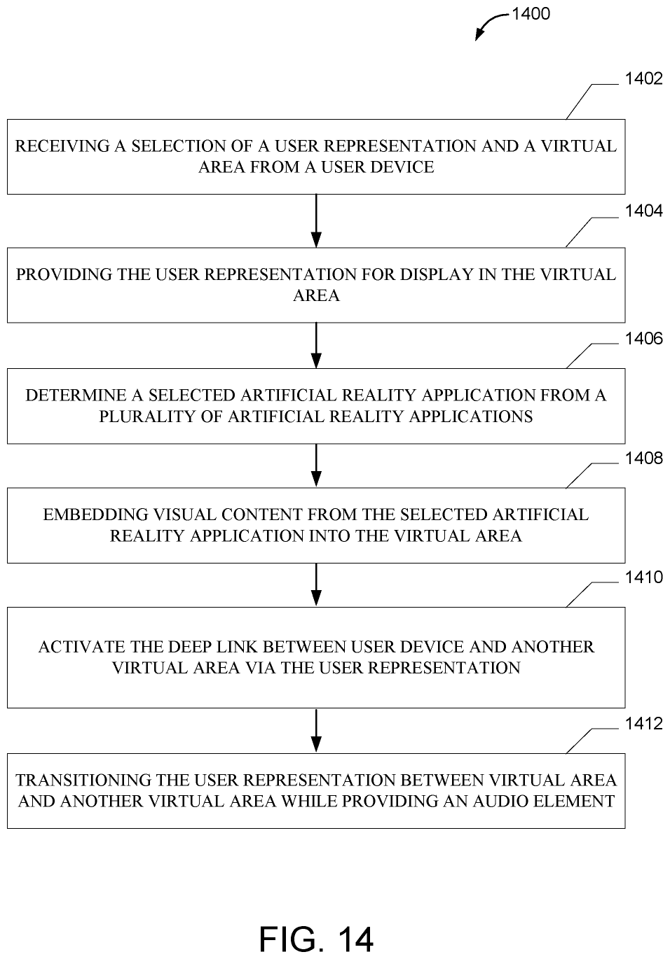

FIG. 14 illustrates an example flow diagram (e.g., process 1400) for activating a link to artificial reality content in a shared artificial reality environment, according to certain aspects of the disclosure. For explanatory purposes, the example process 1400 is described herein with reference to one or more of the figures above. Further for explanatory purposes, the steps of the example process 1400 are described herein as occurring in serial, or linearly. However, multiple instances of the example process 1400 may occur in parallel. For purposes of explanation of the subject technology, the process 1400 will be discussed in reference to one or more of the figures above.

At step 1402, a selection of a user representation and a virtual area for an artificial reality application can be received from a user device (e.g., a first user device). For example, a user input from the user device may be used to select the user representation from a plurality of options. The selection may be made via a display screen (e.g., the display screen 403a). For example, the user may select a virtual area (e.g., XR environments 401a-401b) as an office.

At step 1404, the user representation may be provided for display in the virtual area. According to an aspect, providing the user representation for display can comprise providing a type of avatar (e.g., female avatar 1006a, the male avatar 1006b) for display in the virtual area, a user image for display in the virtual area, or an indication of the user device for display in the virtual area. At step 1406, a selected artificial reality application for use by the user representation in the virtual area may be determined. For example, the selected artificial reality application can be an architectural artificial reality application.

At step 1408, visual content may be embedded from the selected artificial reality application into the virtual area. The visual content can be associated with a deep link to the selected artificial reality application. According to an aspect, the process 1400 may further include sending the deep link to a device configured to execute the selected artificial reality application or render the shared artificial reality environment. According to an aspect, embedding the visual content can comprise determining a three-dimensional visual content to display in the virtual area to another user device. For example, the three-dimensional visual content may be performed via an application programming interface (API). According to an aspect, the process 1400 may further include receiving, via another user representation (e.g., user representation corresponding to user E), information (e.g., a message such as the AR application status indicator 1204d) indicative of a portion of another artificial reality application. The information may be indicative of a level, layer, portion, etc. of an artificial reality application that is different from the selected artificial reality application so that the user/user representation can be informed of the status (e.g., location, progress, time spent in the application, and/or the like) of an associated user/user representation while the associated user representation is engaged in the different artificial reality application.

At step 1410, the deep link between the user device and another virtual area of the selected artificial reality application may be activated. For example, the activation may be performed via the user representation. According to an aspect, activating the deep link may comprise providing an audio indication or a visual indication (e.g., transition indication 606) of another user representation associated with the user representation. The another user representation can be engaged in the selected artificial reality application. According to an aspect, the process 1400 may further include providing display (e.g., via the AR application status indicator 1204a) of an avatar associated with another user device. The avatar may be engaged in the selected artificial reality application. According to an aspect, the process 1400 may further include providing output of audio associated with execution of the selected artificial reality application to the user device. For example, the output of audio may enable the user/user representation perceive the audible or verbal activity of other associated user representations with respect to execution of the selected application.

At step 1412, the user representation may be transitioned between the virtual area and the another virtual area while an audio element indicative of other user devices associated with the another virtual area is provided to the user device. According to an aspect, the transition of the user representation can comprise altering latency perception between the virtual area and the another virtual area. For example, a filter may be applied to hided latency perceived while transitioning between the virtual area and the another virtual area. According to an aspect, the transition of the user representation can comprise displaying a transition indication (e.g., transition indication 606). The transition indication may comprise at least one of: an audio indication, a visual indication, a movement of a three dimensional object file, an interaction of an avatar with the another virtual area, a screenshot, or a loading window.

According to an aspect, the process 1400 may further include sending, via the user representation, a first person view of a setting of the selected artificial reality application. For example, the first person view may be cast to a recipient user representation to a display area (e.g., shared presentation display screen 1102). According to an aspect, the process 1400 may further include generating, based on the embedded visual content, the deep link to the selected artificial reality application for the another user device (e.g., a second user device). According to an aspect, generating the deep link can comprise displaying a popup window on a graphical display of the first user device. The popup window may prompt the first user device to download the selected artificial reality application, for example.

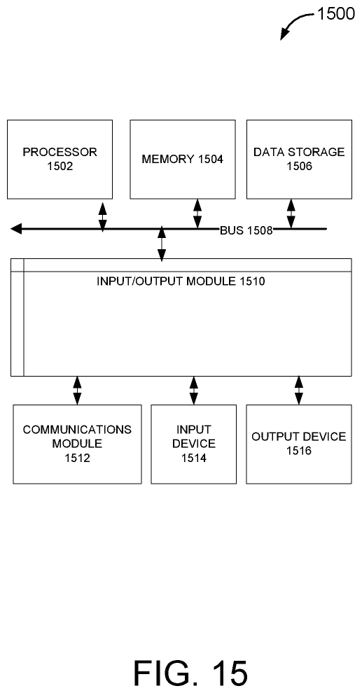

FIG. 15 is a block diagram illustrating an exemplary computer system 1500 with which aspects of the subject technology can be implemented. In certain aspects, the computer system 1500 may be implemented using hardware or a combination of software and hardware, either in a dedicated server, integrated into another entity, or distributed across multiple entities.

Computer system 1500 (e.g., server and/or client) includes a bus 1508 or other communication mechanism for communicating information, and a processor 1502 coupled with bus 1508 for processing information. By way of example, the computer system 1500 may be implemented with one or more processors 1502. Processor 1502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1500 can include, in addition to hardware, code that creates an execution environment for the computer program in question, e.g., code that constitutes processor firmware, a protocol stack, a database management system, an operating system, or a combination of one or more of them stored in an included memory 1504, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1508 for storing information and instructions to be executed by processor 1502. The processor 1502 and the memory 1504 can be supplemented by, or incorporated in, special purpose logic circuitry.

The instructions may be stored in the memory 1504 and implemented in one or more computer program products, i.e., one or more modules of computer program instructions encoded on a computer-readable medium for execution by, or to control the operation of, the computer system 1500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1504 may also be used for storing temporary variable or other intermediate information during execution of instructions to be executed by processor 1502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1500 further includes a data storage device 1506 such as a magnetic disk or optical disk, coupled to bus 1508 for storing information and instructions. Computer system 1500 may be coupled via input/output module 1510 to various devices. The input/output module 1510 can be any input/output module. Exemplary input/output modules 1510 include data ports such as USB ports. The input/output module 1510 is configured to connect to a communications module 1512. Exemplary communications modules 1512 include networking interface cards, such as Ethernet cards and modems. In certain aspects, the input/output module 1510 is configured to connect to a plurality of devices, such as an input device 1514 and/or an output device 1516. Exemplary input devices 1514 include a keyboard and a pointing device, e.g., a mouse or a trackball, by which a user can provide input to the computer system 1500. Other kinds of input devices can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1516 include display devices such as an LCD (liquid crystal display) monitor, for displaying information to the user.

According to one aspect of the present disclosure, the above-described gaming systems can be implemented using a computer system 1500 in response to processor 1502 executing one or more sequences of one or more instructions contained in memory 1504. Such instructions may be read into memory 1504 from another machine-readable medium, such as data storage device 1506. Execution of the sequences of instructions contained in the main memory 1504 causes processor 1502 to perform the process steps described herein. One or more processors in a multi-processing arrangement may also be employed to execute the sequences of instructions contained in memory 1504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1500 can include clients and servers. A client and server are generally remote from each other and typically interact through a communication network. The relationship of client and server arises by virtue of computer programs running on the respective computers and having a client-server relationship to each other. Computer system 1500 can be, for example, and without limitation, a desktop computer, laptop computer, or tablet computer. Computer system 1500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1502 for execution. Such a medium may take many forms, including, but not limited to, non-volatile media, volatile media, and transmission media. Non-volatile media include, for example, optical or magnetic disks, such as data storage device 1506. Volatile media include dynamic memory, such as memory 1504. Transmission media include coaxial cables, copper wire, and fiber optics, including the wires that comprise bus 1508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1500 reads game data and provides a game, information may be read from the game data and stored in a memory device, such as the memory 1504. Additionally, data from the memory 1504 servers accessed via a network, the bus 1508, or the data storage 1506 may be read and loaded into the memory 1504. Although data is described as being found in the memory 1504, it will be understood that data does not have to be stored in the memory 1504 and may be stored in other memory accessible to the processor 1502 or distributed among several media, such as the data storage 1506.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for linking artificial reality content to a shared artificial reality environment, the method comprising:
receiving, from a user device, a selection of a user representation and a virtual area;
providing the user representation for display in the virtual area;
determining, from a plurality of artificial reality applications, a selected artificial reality application for use by the user representation in the virtual area;
embedding visual content from the selected artificial reality application into the virtual area, wherein the visual content is associated with a deep link to the selected artificial reality application;
activating, via the user representation, the deep link between the user device and another virtual area of the selected artificial reality application; and
transitioning the user representation between the virtual area and the another virtual area while providing an audio element to the user device indicative of other user devices associated with the another virtual area.

2. The computer-implemented method of claim 1, wherein providing the user representation for display in the virtual area comprises providing a type of avatar for display in the virtual area, a user image for display in the virtual area, or an indication of the user device for display in the virtual area.

3. The computer-implemented method of claim 1, wherein embedding the visual content from the selected artificial reality application into the virtual area comprises determining, via an application programming interface (API), a three-dimensional visual content to display in the virtual area to another user device.

4. The computer-implemented method of claim 1, wherein activating the deep link between the user device and another virtual area of the selected artificial reality application comprises providing an audio indication or a visual indication of another user representation associated with the user representation, wherein the another user representation is engaged in the selected artificial reality application.

5. The computer-implemented method of claim 1, wherein transitioning the user representation between the virtual area and the another virtual area comprises altering latency perception between the virtual area and the another virtual area.

6. The computer-implemented method of claim 1, wherein transitioning the user representation between the virtual area and the another virtual area comprises displaying a transition indication, wherein the transition indication comprises at least one of: an audio indication, a visual indication, a movement of a three dimensional object file, an interaction of an avatar with the another virtual area, a screenshot, or a loading window.

7. The computer-implemented method of claim 1, further comprising sending the deep link to a device configured to execute the selected artificial reality application or render the shared artificial reality environment.

8. The computer-implemented method of claim 1, further comprising:
providing display of an avatar associated with another user device, wherein the avatar is engaged in the selected artificial reality application; and
providing, to the user device, output of audio associated with execution of the selected artificial reality application.

9. The computer-implemented method of claim 1, further comprising receiving, via another user representation, information indicative of a portion of another artificial reality application.

10. The computer-implemented method of claim 1, further comprising sending, via the user representation, a first person view of a setting of the selected artificial reality application.

11. A system for linking artificial reality content to a shared artificial reality environment, comprising:
one or more processors; and
a memory comprising instructions stored thereon, which when executed by the one or more processors, causes the one or more processors to perform:
receiving a selection of a user representation and a virtual area;
providing the user representation for display in the virtual area;
determining, from a plurality of artificial reality applications, a selected artificial reality application for use by the user representation in the virtual area;
embedding visual content from the selected artificial reality application into a display of a first user device, wherein the visual content is associated with a deep link to the selected artificial reality application;
generating, based on the visual content, the deep link to the selected artificial reality application for a second user device;
activating the deep link between the second user device and another virtual area of the selected artificial reality application; and
transitioning the user representation between the virtual area and the another virtual area while providing an audio element to the second user device indicative of other user representations associated with the another virtual area.

12. The system of claim 11, wherein the instructions that cause the one or more processors to perform generating the deep link to the selected artificial reality application for the second user device cause the one or more processors to perform displaying a popup window on a graphical display of the first user device.

13. The system of claim 11, wherein the instructions that cause the one or more processors to perform embedding the visual content from the selected artificial reality application into the virtual area cause the one or more processors to perform determining, via an application programming interface (API), an image to display to a third user device.

14. The system of claim 11, wherein the instructions that cause the one or more processors to perform activating the deep link between the second user device and another virtual area of the selected artificial reality application cause the one or more processors to perform providing an audio indication or a visual indication of other user representations engaged in the selected artificial reality application at the another virtual area.

15. The system of claim 11, wherein the instructions that cause the one or more processors to perform transitioning the user representation between the virtual area and the another virtual area cause the one or more processors to perform altering latency perception between the virtual area and the another virtual area.

16. The system of claim 11, wherein the instructions that cause the one or more processors to perform transitioning the user representation between the virtual area and the another virtual area cause the one or more processors to perform displaying a transition indication, wherein the transition indication comprises at least one of: an audio indication, a visual indication, a movement of a three dimensional object file, an interaction of an avatar with the another virtual area, a screenshot, or a loading window.

17. The system of claim 11, further comprising stored sequences of instructions, which when executed by the one or more processors, cause the one or more processors to perform:
providing display of other avatars engaged in the selected artificial reality application; and
providing, to the second user device, output of audio associated with execution of the selected artificial reality application.

18. The system of claim 11, further comprising stored sequences of instructions, which when executed by the one or more processors, cause the one or more processors to perform receiving, via another user representation, information indicative of a portion of another artificial reality application.

19. The system of claim 11, further comprising stored sequences of instructions, which when executed by the one or more processors, cause the one or more processors to perform sending, via the user representation, a first person view of a setting of the selected artificial reality application.

20. A non-transitory computer-readable storage medium comprising instructions stored thereon, which when executed by one or more processors, cause the one or more processors to perform operations for linking artificial reality content to a shared artificial reality environment, the operations comprising:
receiving, from a user device, a selection of a user representation and a virtual area;
providing the user representation for display in the virtual area;
determining, from a plurality of artificial reality applications, a selected artificial reality application for use by the user representation in the virtual area;
embedding visual content from the selected artificial reality application into the virtual area, wherein the visual content is associated with a deep link to the selected artificial reality application;
activating, via the user representation, the deep link between the user device and another virtual area of the selected artificial reality application; and
transitioning the user representation between the virtual area and the another virtual area while an audio element is indicative of other user devices associated with the user device.
